(19) United States
(12) Patent Application Publication
(10) Pub. No.: US 2015/0046301 A1
(43) Pub. Date: Feb. 12, 2015

(54) COMMUNITY-BASED USAGE MONITORING

(71) Applicant: Solavei, LLC, Bellevue, WA (US)

(72) Inventors: Ryan K. Wuerch, Medina, WA (US); James P. Ryan, Bellevue, WA (US); Tahlia D. Sutton, Bellevue, WA (US)

(73) Assignee: Solavei, LLC, Bellevue, WA (US)

(21) Appl. No.: 13/962,350

(22) Filed: Aug. 8, 2013

(51) Int. Cl. G06Q 40/00

(52) U.S. Cl. CPC G06Q 40/12
USPC 705/30

(57) ABSTRACT

The present application describes methods, systems, and apparatuses for community-based usage monitoring. An overall service usage, such as an average daily usage for a plurality of subscribers is determined. A service usage for a particular subscriber of the plurality of subscribers is also determined, such as an average daily usage. A metric is determined that indicates a comparison of the service usage to the overall service usage. The metric may be a percentile, standard deviation, or other comparison of the subscriber's usage relative to the overall usage. An indication of the metric is transmitted to a device associated with the first subscriber. Where the subscriber's relative usage exceeds a threshold, an alert is generated flagging the subscriber for action to reduce usage.

### BACKGROUND

Mobile phone service providers often impose a usage cap on their subscribers, even in the case of “unlimited” voice and data service. For example, a cellular subscriber with an unlimited data plan may have a 3.5 gigabyte (GB) per month data download allotment using “fourth generation” (4G) service, after which his or her service reverts to “second generation (2G) service for the remainder of the month, with or without further download limits. But for most non-technical subscribers, a 3.5 GB limit is not meaningful, and they do not know whether that amount is sufficient for their needs.

Service providers often show their subscribers some kind of usage information, such as usage data online or in a monthly bill, which shows the subscriber how much data they use over the course of the month. The subscriber often sees this information too late to make meaningful use of it. Also, the subscriber generally considers the cap on usage to be “fair game”—as long as the subscriber does not exceed their cap, they have no incentive to switch their device to alternative connections, such as Wi-Fi, or otherwise attempt to use less bandwidth.

### BRIEF DESCRIPTION OF THE DRAWINGS

The following description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example environment suitable for providing a community-based usage monitoring service.

FIG. 2 illustrates an example account services page for providing community-based usage monitoring for a subscriber.

FIG. 3 illustrates an example account services page displayed when a subscriber's usage is above a threshold indicating that the subscriber's usage is exceeding, or near to exceeding, a reasonable level.

FIG. 4 illustrates an example account services page displayed to show a subscriber's usage graphs and trendlines.

FIGS. 5A-B illustrate example account services pages for providing community-based usage monitoring information to a subscriber via a mobile device.

FIG. 6 illustrates an example account services page for providing real-time community based usage monitoring information to a subscriber.

FIG. 7 is a flow chart that illustrates an example process for performing community-based usage monitoring.

FIG. 8 is a flow chart that illustrates an example process for providing relative usage information to a subscriber.

FIG. 9 is a block diagram of an example computing system usable to provide the monitoring platform.

### DESCRIPTION OF THE FIGURES

Embodiments of the present disclosure include community-based usage monitoring, or monitoring of subscriber usage with respect to other subscribers, such as subscribers of a mobile service, an electricity service, a water service, or other. Subscribers are provided with information in the form of graphical or textual information, such as displayed on their client devices, that compares their individual usage to the overall usage of other subscribers. Individual usage is not necessarily compared to a usage cap (although in embodiments it may be); instead individual usage is compared relative to overall community usage, and the subscriber is provided with a graphical or textual representation of a relative usage metric, which compares the subscriber's usage relative to the overall usage. This information may be displayed on an online dashboard, provided in a system alert, a text message, an email, or an account services screen.

Subscribers at the high end of overall usage (e.g., subscribers whose average daily usage exceeds 90%, 95%, or 99% of all subscribers), are typically subscribers who violate a provider's acceptable use policy. Acceptable use policies, even for “unlimited” mobile phone plans for example, sometimes prohibit high-bandwidth activities, such as constant video streaming, tethering to other devices, using the device as a mobile hotspot, placing a SIM card into an unauthorized device, such as a game console, and so forth. Identifying the top consumers of bandwidth, regardless of their absolute usage, is often a way to identify subscribers who violate the acceptable use policy. Therefore, individual usage may be compared to some measure of overall usage by all subscribers. Subscribers who are high consumers of the service are identified for warning and/or action to reduce usage, such as a customer service phone call, service suspension or cancellation, throttling, service downgrade (e.g., 3G to 2G service), special monitoring, usage caps, and so forth.

The subscribers may participate in a social commerce community. A social commerce community may include members or entities that participate in a social commerce system. In one example, a social commerce community may be a community of members who have signed up for a service, such as a mobile phone service, an energy service (e.g., electricity, natural gas), a cable service, or other service. The members may also participate in both offline and e-commerce activities that involve buying and selling of goods, buying electronic media, and so forth. The members have the opportunity to recruit additional members into the community, who then become subscribers to the service. The recruited members become part of the member's network, and the member may be compensated based on the number of members (e.g., service subscribers) within his or her network, and may be compensated for other activities of the members in their networks, such as purchases made by the members within their network. A member's sponsor is another social commerce participant/member who is directly above the member within the social commerce community. The sponsor acts as the new member's primary relationship within the social commerce community. An individual subscriber's relative usage metrics may be shown to other community members, and/or to other members of their networks, such as their sponsor. This exposure may apply social pressure to a high-bandwidth consumer to take steps to reduce their usage. In embodiments, the subscribers may receive incentives based on bandwidth usage, such as increased commissions or bonuses that result from lowered overall usage by members of the social commerce community, members of one's network, or other group of subscribers (such as subscribers in a particular subscriber's plan type).

Various examples given below illustrate monitoring mobile phone service usage (both voice and data). But embodiments are not limited to monitoring mobile phone service usage; various embodiments include monitoring the amount of water utility usage, electricity usage, natural gas usage, and so forth. The techniques and systems described herein may be implemented in a number of ways. Example implementations are provided below with reference to the following figures.

### Example Environment

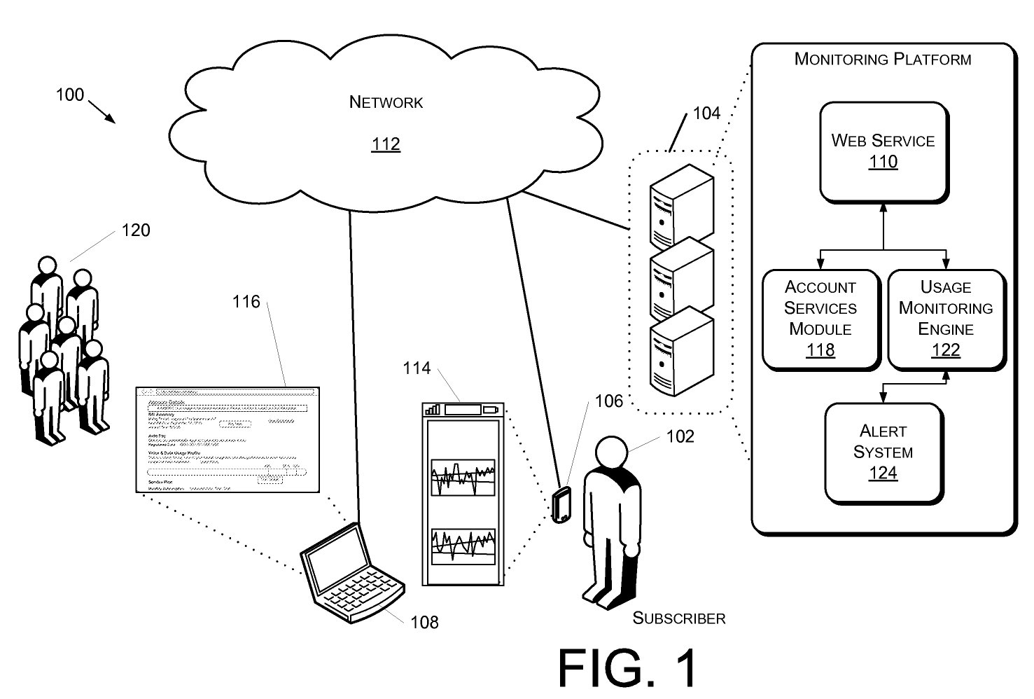

FIG. 1 illustrates an example environment 100 suitable for providing a community-based usage monitoring service. A subscriber 102 is a service subscriber, such as a mobile phone service subscriber, electricity service subscriber, water service subscriber, or other service subscriber. Where the service is a mobile service, the mobile service (voice service, data service, or both) may be provided to the subscriber 102 via a mobile device 106, although in other embodiments it may be provided via some other mobile device. In some embodiments, the mobile device 106 and/or personal computer 108 access a web service 110 via a network 112 and an installed browser or a soft link. One or more screens may be cached or stored locally on the mobile device 106 or the personal computer 108 to enable the browser to access the screens directly rather than via the web service 110. Although the mobile device 106 is shown in FIG. 1 as a touch-screen phone or tablet computer, and the personal computer 108 is illustrated in FIG. 1 as a laptop computer, the subscriber 102 may utilize various other types of devices to utilize the service and/or to receive usage monitoring information on, such as game consoles, televisions, electricity meters, natural gas meters, water meters, desktop computer, server, smart appliance, or other.

The mobile device 106 accesses an account information screen 114 via the web service 110. The personal computer 108 accesses an account information screen 116 via the web service 110. The account information screens 114 and 116 may include the same or similar information. The account information screen 114 may be a mobile-formatted screen, with a reduced amount of information and/or a format suitable for display on the smaller screens of a typical mobile device, such as the mobile device 106.

The account information screens 114 and 116 are provided by an account services module 118. The account information screens 114 and 116 provide information regarding the subscriber's account, such as a plan type (e.g., “unlimited voice and data”), billing information, plan dates, options to upgrade, and options to purchase new devices, pay bills, and so forth.

In addition, the account services module 118 provides information regarding the subscriber's usage, including their usage relative to overall usage of a community of subscribers 120. A usage monitoring engine 122 determines the overall usage of a community of subscribers 120. The community of subscribers 120 includes a group of subscribers who subscribe to the same service as subscriber 102. For example, the community of subscribers 120 may include subscribers having the same plan type, subscribers belonging to the subscriber's 102 social commerce network, and so forth. The community of subscribers 120 may include social network contacts (as distinct from the subscriber's social commerce network members, e.g., friends, contacts, followers, and so forth of the subscriber 102). The community of subscribers 120 may include all subscribers to a particular service, such as a mobile service, television service, energy service, and so forth. In embodiments, the community of subscribers 120 includes the subscriber 102; the subscriber 102 is shown separately in FIG. 1 for the sake of illustration.

The usage monitoring engine 122 analyzes usage of the community of subscribers 120 over a period of time (such as the previous 30 days), and determines usage for the subscriber 102, as well as for the other subscribers within the community of subscribers 120. The usage monitoring engine also provides comparison metrics that compare the usage of the subscriber 102 to the overall usage of the community of subscribers 120 in a way that allows for meaningful comparison.

The time period used by the usage monitoring engine 122 to calculate and compare usage may be a rolling period of time, such as the previous 5, 10, 15, 20, 30, 60, or other number of days. The rolling period of time may be based on seconds, minutes, hours, days, weeks, months, years, etc. The period of time may be a non-rolling period of time, such as since the beginning of the hour, day, month, quarter, year, or the time since service plan reset (e.g., when the subscriber's plan resets to a new month or other billing period).

The usage monitoring engine 122 may determine the subscribers' total usage during the time period. For example, the usage monitoring engine 122 may determine the subscribers' total number of voice minutes or calls for a rolling 30-day period, or may determine the subscribers' total data download and/or upload volume (such as in Megabytes of Gigabytes) over the time period. In other examples, the usage monitoring engine 122 may determine the subscriber's 102 total electricity (e.g., total kilowatt hours) used during the time period or their total volume of residential water use during the time period.

Alternatively, the usage monitoring engine 122 may determine usage over a plurality of increments of the time period, such as an hourly, daily, or weekly usage over the time period. In embodiments, the usage monitoring engine 122 may utilize an average daily usage. The average daily usage may be determined, for example, based on an average total usage for each 15-minute period (or other time period) throughout a single day. The average may be either an arithmetic average (e.g., a mean) or it may be a median or mode determination.

Instead of an average usage for each increment (such as average daily usage), other measures of usage for each increment may be employed, such as the peak usage of each day, the Xth percentile period for each day (such as the usage during the 15-minute period from each day where usage is higher than 75% of the other 15-minute periods during the day), or based on standard deviation (such as the usage period from each day that is one standard deviation from the mean for the day).

Usage may be determined from usage data from the entire day, or only during certain times of the day, such as from 6 AM to 10 PM. Or the usage may be determined after discarding the top and bottom periods (the peak and minimum periods) from each day, or after discarding the top three and bottom three periods, or the top 5% and the bottom 5%, or some other number of periods to avoid anomalous measurements.

Other measures of usage throughout the time period may be employed without departing from the scope of embodiments.

Whatever the metrics used to determine the subscribers' usage during the time period, the usage monitoring engine 122 determines comparison metrics for one or more of the subscribers within the community of subscribers 120, including the subscriber 102. The comparison metric indicates a comparison of the overall usage of the community of subscribers 120 to the usage of the subscriber 102.

The comparison metrics may include a comparison of the subscriber's 102 usage to an average usage of the community of subscribers 120. For example, the metric may indicate a ratio of the subscriber's 102 usage to the average, such as a factor of X, where X may be 0.75 of the average, 2.5 times the average, 2/3 of the average, and so forth.

The metrics may include a percentile that the subscriber's 102 usage falls into, for example the Xth percentile, indicating the percentage of subscribers within the community of subscribers 120 who have lower usage over the time period than the subscriber 102. For example, the metric may indicate that the subscriber 102 is in the 20th percentile, indicating that 20% of the subscribers in the community of subscribers 120 have lower usage than the subscriber 102. In another example, the metric indicates that that the subscriber 102 is in the 80th percentile, indicating that 80% of the subscribers have lower usage than the subscriber 102.

The usage monitoring engine 122 may calculate other comparison metrics. For example, the subscriber's 102 standard deviation from the mean (above or below) could be computed, such as one standard deviation from the mean, two standard deviations from the mean, 3.5 standard deviations from the mean, and so forth.

The usage monitoring engine 122 may calculate the comparison metric as a range. For example, the usage monitoring engine 122 may calculate that the subscriber 102 is between the 80^{th} and 90^{th} percentile of subscribers, or has between 2.5 and 3 times the average usage. Other ranges could be used without departing from the scope of embodiments.

The usage monitoring engine 122 provides the determined comparison metric for the subscriber 102 to the account services module 118 and/or the web service 110 for display on an account information screen, such as the account information screens 114 and 116. The usage monitoring engine 122, in some embodiments, causes other forms of communication to be sent to the subscriber including the subscriber's comparison metric, such as a text message, an email, a social networking message, a system alert on the mobile device 106, an automated telephone call or voicemail, and so forth.

The usage monitoring engine 122, account services module 118, and/or the web service 110 may also cause the account information screens 114 and 116 to display one or more alerts, warnings, flags, or other notifications indicating that the subscriber's 102 usage has reached one or more thresholds, relative to the overall usage of the community of subscribers 120. In one non-limiting example, the notifications may include a textual or graphical warning that the subscriber's 102 usage exceeds a first threshold percentile (e.g., the subscriber's 102 usage at or above the 80^{th} percentile) indicating that the subscriber's 102 usage is approaching excessive. A second threshold (e.g., the 90^{th} percentile) indicates that the subscriber's 102 usage has reached excessive levels, and a third threshold (e.g., the 95^{th} percentile) indicates that the subscriber's 102 usage is excessive and that the subscriber's service account is flagged for action, such as a customer service call or message, throttling, service suspension, service termination, reduced service level, imposition of a voice or data cap, and so forth.

Various examples notifications, whether included in an account services screen or other forms of communication such as email, text message, system alert, and so forth, may include textual warnings, a usage bar that indicates the subscriber's 102 relative usage, a usage graph showing a comparison of the subscriber's usage to the usage of the community (such as an average usage of the community), notification boxes that include warnings and that may be highlighted in various colors to indicate the relative usage level, and so forth. Other alerts and warnings may be employed, such as audio alerts on the mobile device 106, audio alerts that are played whenever a user attempts to make a call, and so on.

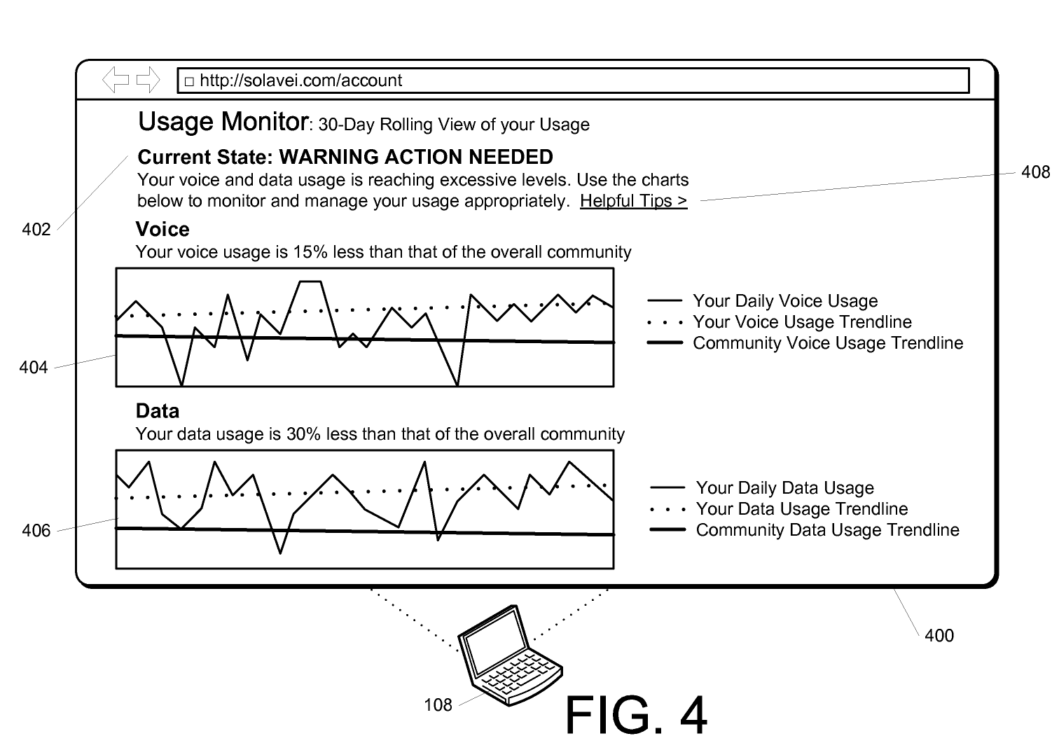

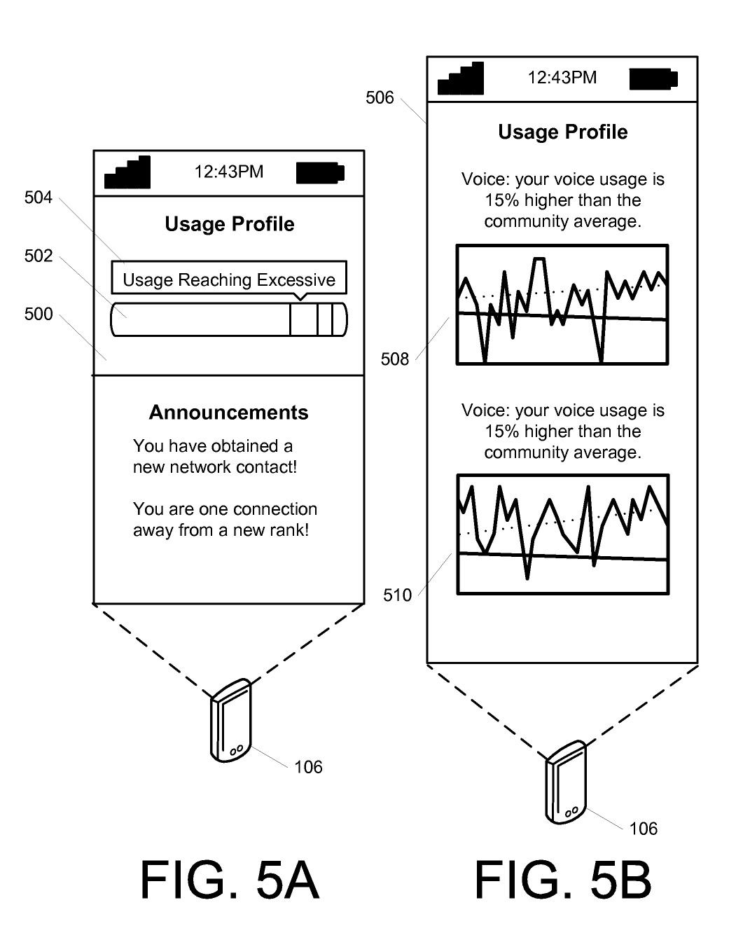

The usage monitoring engine 122 determines trendlines for the individual subscribers, including the subscriber 102, as well as an overall trend line for the community of subscribers 120. For example, a graph showing the subscriber's 102 daily usage (such as daily average usage, daily peak usage, daily 75^{th} percentile usage, and so forth) over the period of time, juxtaposed with the overall community's average daily usage trendline and/or the subscriber's 102 trendline for the period of time may be displayed in an account service screen. The trendlines indicate whether the trend over the period of time (such as the previous 30 days) is increasing, decreasing, or staying the same. The average daily usage tends to fluctuate from day-to-day, but it is useful for the subscriber to see, at a glance, whether their particular overall trend is going up or down, and to compare their trendline to the overall community trendline. The comparison may also apply social pressure to decrease their usage, such as where the overall community usage goes down, while the subscriber's 102 usage goes up, stays flat, or decreases at a slower rate than the overall community usage. The usage monitoring engine 122, account services module 118, and/or the web service 110 causes these graphs, including the trendlines, to be displayed within the account information screen 114 and 116, to be included in an email. In embodiments, emails, text messages, social networking messages, system alerts and so forth may include links to an account services page that shows on or more notifications, including graphs. Example graphs are shown in FIGS. 4 and 5B.

The usage monitoring engine 122 may also, in various embodiments, convert the subscriber's usage into estimated pollution levels associated with that usage. For example, every minute of voice calling may be determined to be associated with a certain amount of greenhouse gases (such as carbon dioxide, carbon monoxide, or other), soot, ozone depleting chemicals, or other pollutants, released into the atmosphere. In another example, a certain amount of data transmission may similarly be associated with pollution levels. Likewise, electricity or natural gas usage may be convertible to greenhouse gas or other pollutant emissions. In these embodiments, the usage monitoring engine 122 may determine and cause to be transmitted, either instead of or in addition to, the direct usage comparison metrics, comparison metrics that compare the subscriber's pollution levels associated with their usage to an overall community pollution level. In other words, the usage bars, warnings, graphs, trendlines, and other textual and graphical warnings and alerts described herein that enable a subscriber to monitor their service usage may indicate relative pollution levels instead of, or in addition to, relative usage levels of the service itself.

The usage monitoring engine 122 flags the accounts of those subscribers within the community of subscribers 120 whose usages are exceed a threshold relative usage, such as the top 5% of subscribers by usage or other measure of excessive usage. The usage monitoring engine 122 provides flags, reports, or other indicators to the alert system 124 indicating those subscribers within the community of subscribers 120 who have excessive usage, and who are flagged for action, based on a determination that their relative usages exceeding an associated threshold.

The alert system 124 is configured to cause one or more actions. The actions may include alerting a person (e.g., a customer service employee) to contact the flagged subscriber. The action may include automatic service throttling, automatic service level change (such as to 2G from 4G service), temporary service suspension, and so forth. Thus, the usage monitoring performed by monitoring platform 104 not only causes indications and notifications to be transmitted to the subscriber regarding the subscriber's relative, community-based usage levels, but also in the case of excessive usage (defined relative to the overall community's usage), the monitoring platform 104 initiates some action for those subscribers that meet an excessive usage threshold.

The monitoring platform 104 may be part of, in communication with, or otherwise share infrastructure with, a social commerce platform that provides various social commerce services to the subscribers within the community of subscribers 120, including the subscriber 102. These services may include a social network service, a social network feed, motivation services that provide timely information regarding the subscribers' compensation status and actions to take to increase compensation, and so forth. In various online views provided by this social commerce service, information regarding members of the subscriber's network is shown to a social commerce participant, such as the subscriber 102. In various embodiments of the present disclosure, this member information is augmented with the members' relative usage information, such as an indicator using a common color scheme to signify relative usage (e.g., green, yellow, orange, and red), an indication of the member's percentile, comparison to the average, standard deviation from the mean, and so forth. Augmenting the social commerce information with member usage information may provide additional social pressure on the members, who will be aware that their usage is being shown to their sponsor or to other members in their networks.

Also, in various embodiments, the social commerce system provided by the monitoring platform 104 may provide various additional incentives to reduce usage, such as increasing commissions or payments, or taking a portion of monetary savings from reduced usage and distributing it to members. These techniques make members of the community accountable to one another to reduce usage. In addition, metrics indicating correlation of increased profits and bonuses with reduced usage may b presented to the subscribers.

Also, instead of taking action against the subscriber with excessive usage, the subscriber may be offered the ability to purchase or earn additional usage, such as by recruiting additional members to join the social commerce community, and so forth.

### Example Account Information Screens

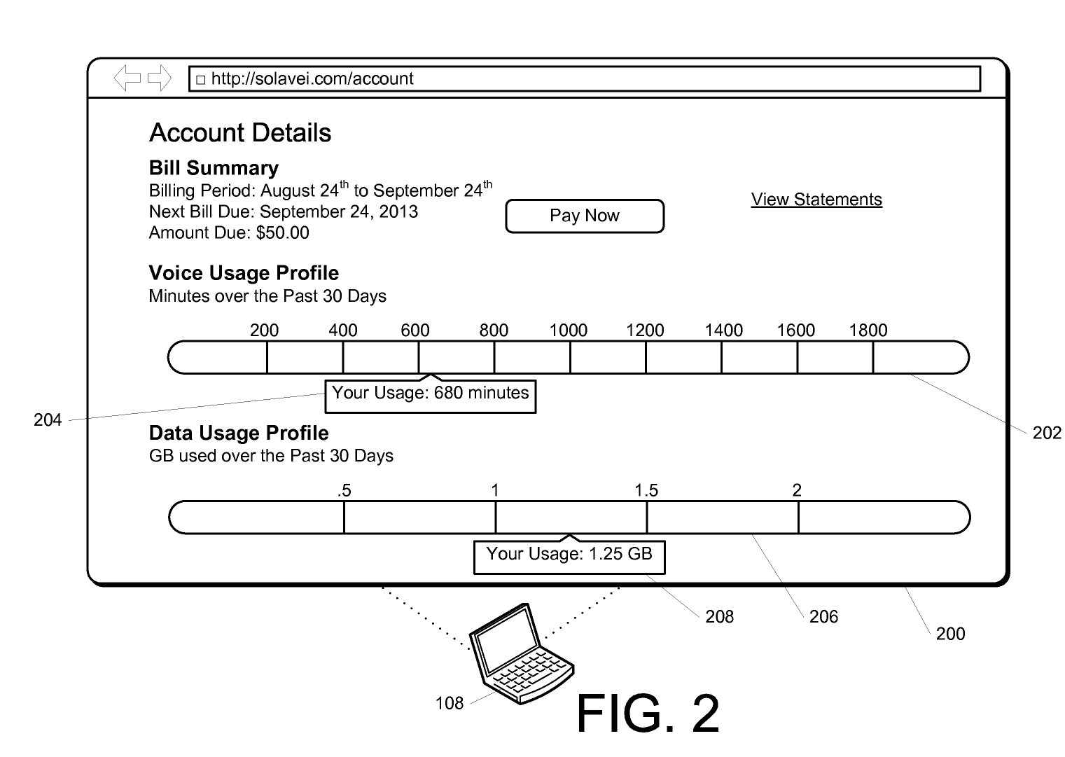

FIG. 2 illustrates an example account services page 200 for providing community-based usage monitoring for a subscriber. Account services page 200 includes an “Account Details” page for a subscriber to a service, such as the subscriber 102. In this example, the subscriber's relative voice and data usage are below a certain threshold of relative usage, such as below the 80^{th} percentile of subscribers, or other threshold. Thus, a voice usage bar 202 includes a usage scale, and an indicator 204 that shows the user's actual usage. The voice usage bar 202 may be shaded a color to indicate that the usage is reasonable; for example, the usage bar may be shaded green, purple, or other color.

In various embodiments, both the subscriber's voice and data usage is monitored. The data usage bar 206 is displayed as shown in FIG. 2, with an indicator 208 indicating that the subscriber's data usage is within what is considered reasonable levels. The data usage bar 206 includes a usage scale shown in gigabytes. Alternative embodiments may utilize different scales for the voice usage bar 202 or the data usage bar. For example, the voice usage bar 202 scale may be a percentile, a number of phone calls, and so forth. The data usage bar scale, the scale may be an amount of data (megabytes, gigabytes, terabytes, terabits, etc.), in percentiles, or other.

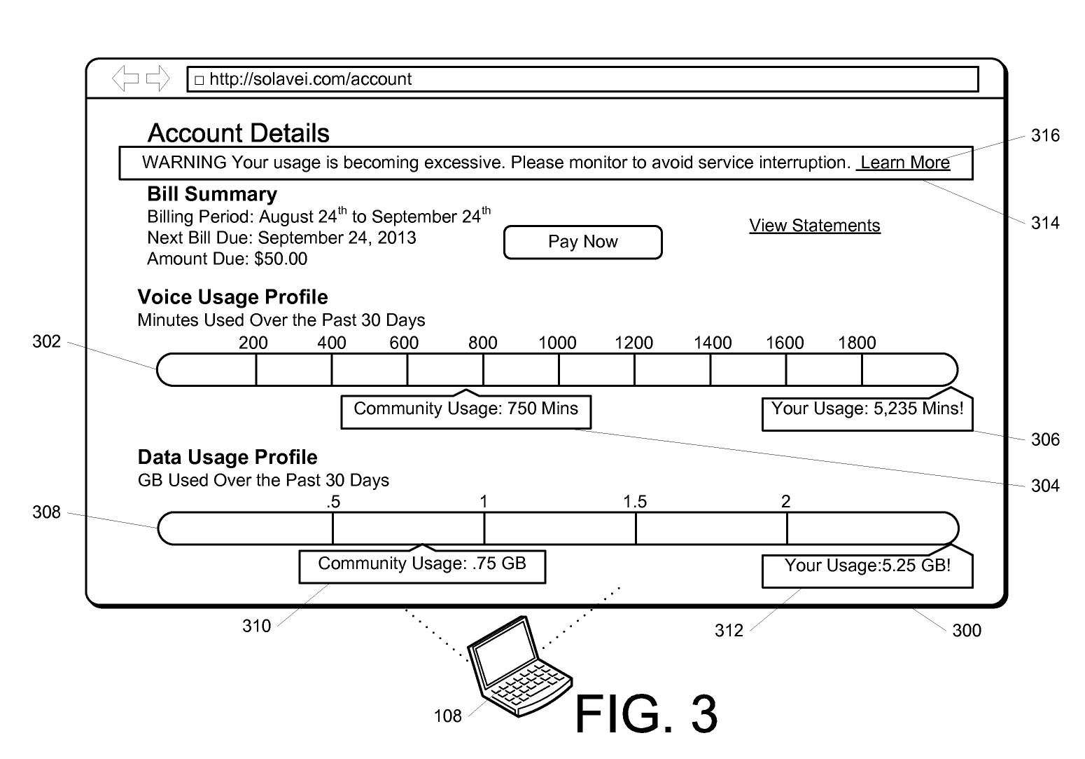

FIG. 3 illustrates an example account services page 300 displayed when a subscriber's usage is above a threshold indicating that the subscriber's usage is exceeding, or near to exceeding, a reasonable level. A voice usage bar 302 includes a voice minute scale (although as with FIG. 2 other scales may be used), an indicator 304 showing the community average usage, and an indicator 306 showing the user's usage, which is excessive for being above a certain threshold.

A data usage bar 308 includes a gigabyte scale (although as with FIG. 2 other scales may be used), an indicator 310 showing the community average usage, and an indicator 312 showing the user's usage, which is excessive for being above a certain threshold.

In alternative embodiments, not illustrated in FIG. 3, the usage bar 302 and the data usage bar now includes percent markers (e.g., 80%, 90%, and 95%). These markers indicate various threshold percentiles. A warning message 314 tells the subscriber “WARNING Your usage is becoming excessive. Please monitor to avoid service interruption.” The box surrounding the warning message 314 may be shaded, animated, flashing, or have other visual affect to draw attention to it; for example it may be shaded red. A “learn more” link 316 may be present, which may be selectable to bring up another page that shows the subscriber's daily usage graphs, as are illustrated in FIG. 4.

Referring back to the voice usage bar 302 and the data usage bar 308, portions at the high-usage ends may be shaded a different color than the rest of the usage bar to indicate where the cut-off between excessive and reasonable usage levels are, such as red to indicate excessive and purple, green, or other color to indicate reasonable levels. The red level may indicate a threshold percentile, such as 80%, 90%, 95%, of other. In embodiments, a first portion of the voice usage bar 302 and/or the data usage bar 308 indicating that usage is less than the 80^{th} percentile may be shaded a first color, such as green. Another portion of the voice usage bar 302 and/or the data usage bar 308 indicating that the subscriber's usage is between the 80^{th} percentile and the 90^{th} percentile may be shaded a second color, such as yellow. A third portion of the voice usage bar 302 and/or the data usage bar 308 indicating that the subscriber's usage is between the 90^{th} and 95^{th} percentile may be shaded a third color, such as orange. And a fourth portion of the voice usage bar 302 and/or the data usage bar 308 indicating that the subscriber's usage is above the 95^{th} percentile may be shaded a fourth color, such as red. Other colors or shadings may be utilized, according to various embodiments.

Account services page 300 is displayed when both voice or data usage exceed a threshold relative usage. If data usage is within reasonable relative levels for one of voice or data, then something similar to the voice usage bar 202 or the data usage bar 206 may be displayed in the account services page 300.

Alternatives to the Account Services pages 200 and 300 may be employed in embodiments. For example, a single usage bar (or other graphical illustration of usage) may be displayed with a first indicator showing voice usage and a second indicator showing data usage. Such alternative embodiments may employ two scales (one for each of voice and data) or a single scale that applies to both, such as percentiles. Other examples are possible without departing from the scope of embodiments.

FIG. 4 illustrates an example account services page 400 displayed to show a subscriber's usage graphs and trendlines. The account services page 400 may be displayed upon selecting the “learn more” link 306, as shown in FIG. 3. A warning message 402 indicates that action is needed, such as when either voice or data usage is above a threshold level compared to overall usage of a community of subscribers.

A voice usage graph 404 is displayed showing the subscriber's daily averages over a period of time (such as a rolling 30-day period). A data usage graph 406 is displayed showing the subscriber's daily averages over a period of time (such as a rolling 30-day period). Trendlines, such as the subscriber's voice and data trendlines as well the community's voice and data trendlines are also displayed in their respective graphs. In the example shown in FIG. 4, the subscriber's voice and data trendlines are increasing, while the overall community trendlines are decreasing. Thus, the user is able to see at a glance not only how his or her voice and data usage compares to the overall community's usage, but is given a visual indicator showing how those relative usages change over time. A “Helpful Tips” link 408 is also provided, which is selectable to cause a pop-up or other webpage to be displayed including tips for reducing usage, such as tips to enable Wi-Fi connections when available, to avoid streaming video for extended period unless Wi-Fi connections are available, to download application updates and to download new applications when Wi-Fi connections are available, and so forth. The tips may be specific to the subscriber's particular usage patterns; for example, where traffic analysis identifies large periodic downloads, it may conclude that the subscriber's device is configured to download software updates automatically, and the tip provided to the subscriber may be to download updates manually when Wi-Fi is connected. A similar link may be presented in other Account Services pages, such as those shown in FIGS. 2 and 3.

FIGS. 5A-B illustrate example account services pages for providing community-based usage monitoring information to a subscriber via a mobile device. FIG. 5A illustrates an account service page 500 showing a “Usage Profile” that includes a usage bar 502, which is similar to the voice usage bars 202, 206, 302, and 308 shown in FIGS. 2 and 3. An indicator 504 indicates that the subscriber's usage is above a threshold indicating that the subscriber's usage is nearing excessive. FIG. 5B illustrates an account services page 506 showing a voice usage graph 508 and a data usage graph 510, which are the same as or similar to the voice usage graph 404 and data usage graph 406, respectively, including daily usage, the subscriber's trendline, and the community trendline.

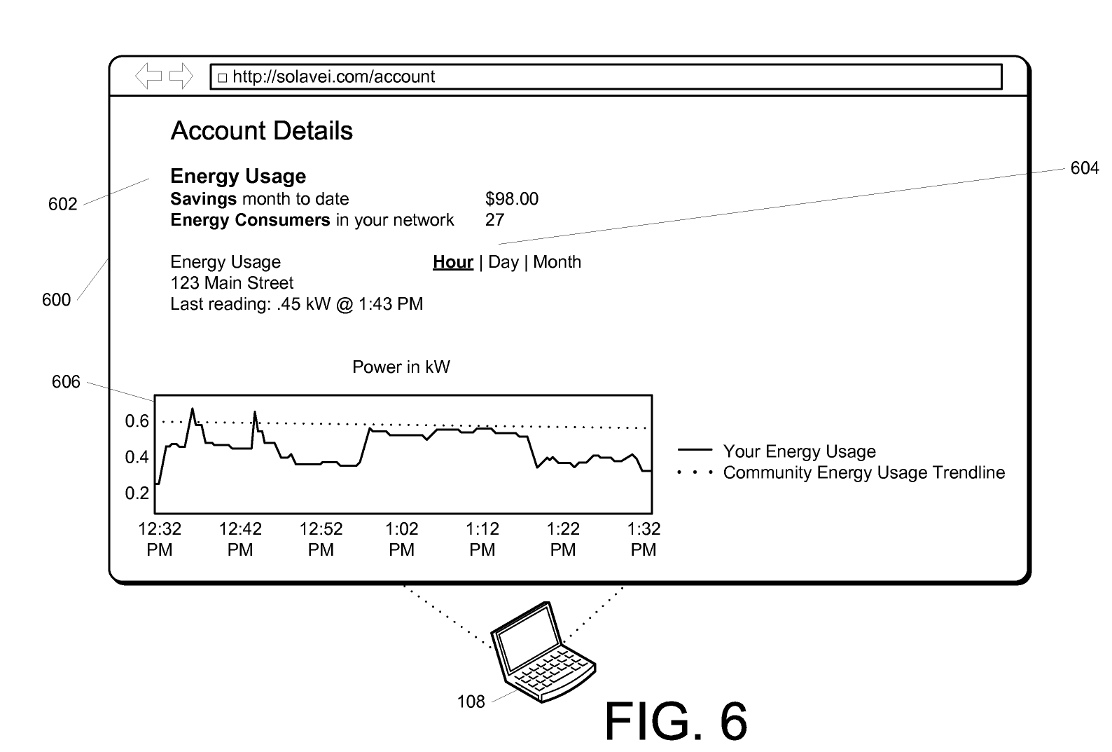

FIG. 6 illustrates an example account services page 600 for providing real-time or near real-time community based usage monitoring information to a subscriber. The account services page 600 illustrates energy usage for a community member who subscribes to an energy service, but in various embodiments similar account service pages are displayed for other types of services, such as for mobile service data or voice service. The account services page 600 includes a summary 602 of the subscriber's energy usage, including monthly savings to date and the number of energy consumers in the subscriber's network. The savings to date may be based on reduction of energy usage, such as the amount of energy saved by the community, members of their network, or based on their own individual energy usage reduction. The reductions may be based on a baseline energy usage taken from similarly situated energy consumers, or from historical data related to the subscriber's past energy usage, and so forth.

The account services page 600 includes options 604 for the subscriber to view their own personal energy usage on an hourly, daily, or monthly basis, although in other embodiments more or fewer options may be presented. Selecting the monthly option may result in a monthly usage graph for energy usage that is similar to the voice and data usage graphs illustrated in FIGS. 4 and 5B. In the example illustrated in FIG. 6, the hourly option is selected (indicated by being underlined and bolded in FIG. 6), which results in the display of graph 606. The graph 606 shows real-time power usage in kilowatts (kW) over the previous hour. Thus, the subscriber is able to view his or her household power usage in real-time or near real-time, thereby seeing how running different appliances, and the like, influences power consumption.

A community usage trendline is also visible in graph 606, which shows the subscriber how their household compares to the community over the period of time. The community usage trendline may be based on all community members, members of the subscriber's network (or a subset of the subscriber's network), or some other subset of the community, such as those community members with similar-sized residences (based on square footage for example, or number of family members, etc.), those located within the same geographic region as the subscriber (e.g., same ZIP code, same street, same city, same state, etc.), those community members with similar historical energy usage, and so forth. Thus, the community energy usage trendline may provide a meaningful comparison for the subscriber.

### Example Processes

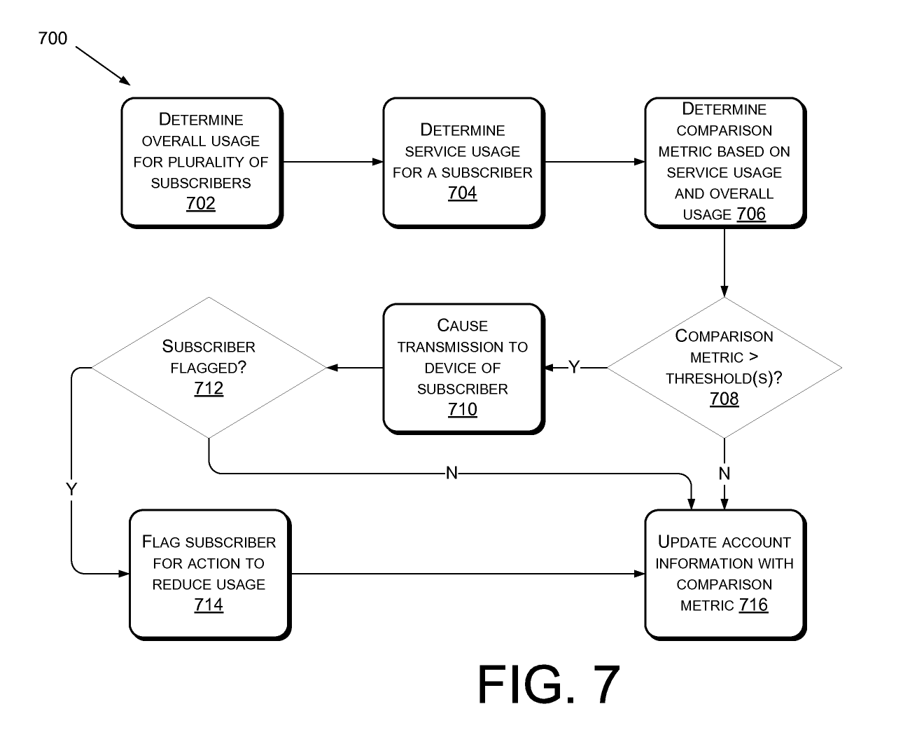

FIG. 7 is a flow chart that illustrates an example process 700 for performing community-based usage monitoring. At 702, a monitoring platform, such as the monitoring platform 104, determines an overall service usage for a plurality of subscribers. The overall service usage is determined over a period of time, such as a rolling period of time, or a period of time since a fixed date in the past, such as the last service reset date of one or more of the subscribers. The overall service usage may include average, peak, or other usage for each day within a previous 30-day rolling period, although in some embodiments, other overall service usages are employed. Determining the overall usage of the plurality of subscribers may be performed periodically, such as once daily so that updated information may be provided to the subscribers each day to show their relative usages.

At 704, the monitoring platform determines a service usage for a particular subscriber of the plurality of subscribers. The service usage for the particular subscriber may include average, peak, or other usage for each day within a previous 30-day rolling period, although in some embodiments, other service usages are employed.

At 706, the monitoring platform determines a comparison metric that indicates a comparison of the subscriber's service usage to the overall service usage. The metric may be a percentile, or range of percentiles, that the particular subscriber's usage falls into. The metric may be a comparison of the subscriber's usage to the average subscriber's usage. The metric may be a number of standard deviations from the mean that the subscriber's usage falls into. Other metrics may be employed without departing from the scope of embodiments.

At 708, the monitoring platform determines whether the comparison metric exceeds any relative usage thresholds, such as a threshold percentile, threshold standard deviation above the mean, or other relative usage threshold. Determining whether the comparison metric exceeds a relative usage threshold may include determining whether the comparison metric falls into one or more ranges of comparison metrics. In embodiments there may be more than two ranges of comparison metrics. In one non-limiting example, there may be a first range (e.g. less than 80^{th} percentile) indicating that the subscriber's usage is not excessive; a second range (e.g. between 80^{th} and 90^{th} percentile) indicating that the subscriber's usage is nearing excessive, a third range (e.g. between 90^{th} and 95^{th} percentile) indicating that the subscriber's usage is excessive, and a fourth range (e.g., above 95^{th} percentile) indicating that the subscriber's usage is excessive and that the subscriber's account is flagged for action to reduce usage.

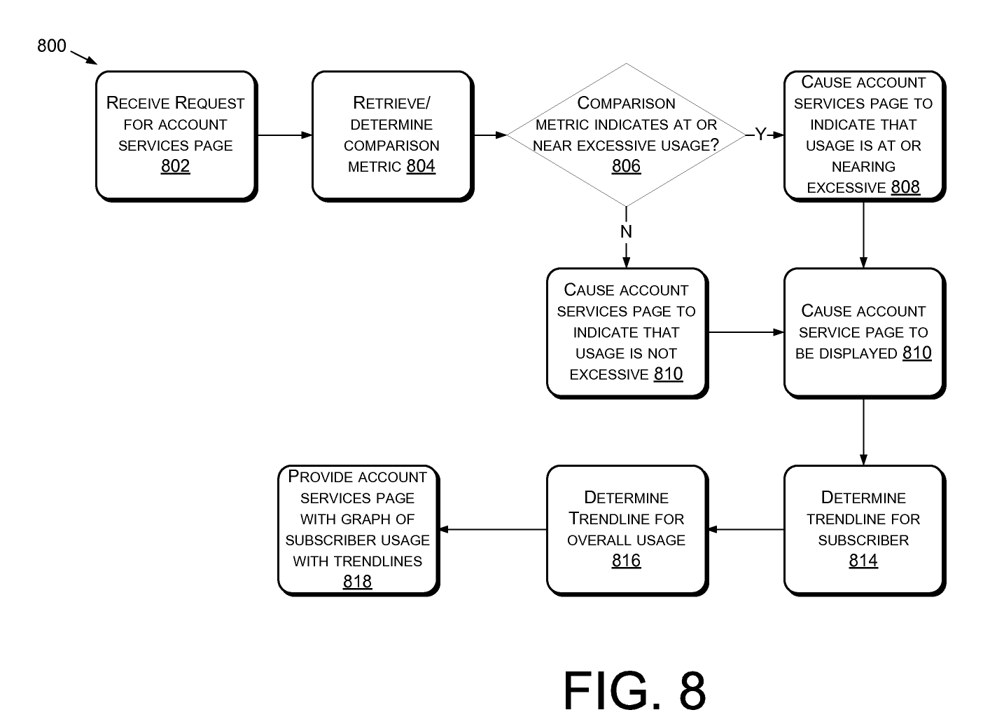

Upon determining at 708 that the subscriber's relative usage metric exceeds a threshold (“Y”), at 710 the monitoring platform may cause a transmission to be transmitted to a device of the subscriber, such as the mobile device 106 or the personal computer 108. The transmission may include an email, a text message, a system alert, an automated phone call, an automated voicemail, and so forth, that indicates that the subscriber's relative usage is at or near an excessive level. This is a “push” method of alerting the subscriber that their relative usage is at or near excessive. A “pull” method of alerting the subscriber is described with respect to FIG. 8. In various embodiments, push alerts may be used, pull alerts may be used, and both push and pull alerts may be used.

At 712, the monitoring platform determines whether the subscriber's service is flagged for action to reduce usage. A subscriber's relative usage metric may exceed a first threshold as determined at 708, but not exceed a second threshold at 712 indicating that the account is flagged for action. If the relative service metric exceeds the action threshold (“Y”), then at 714, the monitoring platform flags the subscriber for action to reduce usage. Flagging the subscriber for action to reduce usage may result in various actions taking place including causing a customer service call to be made to the subscriber, reducing a service level, throttling the service, suspending or cancelling the service, imposing a usage cap on the subscriber's service, and so on.

At 716, the subscriber's account information is updated with the comparison metric and any relative usage thresholds that the subscriber's comparison metric exceeds. The account information may be stored in a subscriber or member information database. Updating the subscriber's account information enables indications of the subscriber's relative usage levels to be presented or transmitted to the subscriber's device and/or to devices of other members of a community, such as members of a social commerce community as is described elsewhere within this Detailed Description.

FIG. 8 is a flow chart that illustrates an example process 800 for providing relative usage information to a subscriber. At 802, a monitoring platform receives a request for an account services page from a device associated with a subscriber to a service, such as a mobile service, an electricity service, a water service, or other service. Responsive to the request, at 804, the monitoring platform retrieves or determines a comparison metric for the subscriber, such as is described in more detail with respect to FIG. 7. Retrieving the comparison metric may include retrieving the comparison metric from account information, such as from a subscriber or member database. In some embodiments, the comparison metric may be outdated or non-existent, and the comparison metric is then determined responsive to receiving the request for the account information page.

At 806, the monitoring platform determines whether the comparison metric indicates that the subscriber's relative usage is at or near an excessive level. This may be a determination that the relative usage metric exceeds one or more thresholds, as is described in more detail elsewhere within this Detailed Description. Alternatively, the determination is based on referring to such information already determined and stored in the subscriber's account information.

Upon determining that the subscriber's relative usage is at or nearing excessive (“Y”), at 808, the monitoring platform causes an account services page, such as the account service page 300 in FIG. 3 to indicate that the subscriber's relative usage is at or nearing an excessive level.

Upon determining that the subscriber's relative usage is not at or nearing excessive (“N”), at 810, the monitoring platform causes an account services page, such as the account services page 200 in FIG. 2 to indicate that the subscriber's relative usage is not excessive.

At 812, the monitoring platform transmits or otherwise causes display of the account services page. The account services page may be a web page, such as is provided by the web service 110. In alternative embodiments, the account services page may be a page displayed and generated by an application executing on the subscriber's device, and the monitoring platform may simply update the device with the appropriate account information, including the subscriber's relative usage information.

At 814, the monitoring platform determines a trendline for the subscriber. The trendline shows how the subscriber's usage changes over the relevant period of time (such as over a 30-day rolling time period), and may be calculated using various mathematical or statistical techniques, such as regression analysis to identify a “best fit” or other fit of the subscriber's usage over time to identify how the usage changes over time.

At 816, the monitoring platform determines a trendline for the overall usage of the plurality of subscribers. As with the subscriber's trendline, this trendline shows how the average subscriber's usage changes over the relevant period of time (such as over a 30-day rolling time period), and may be calculated using various mathematical or statistical techniques, such as regression analysis to identify a “best fit” or other fit of the subscriber's average usage over time to identify how the overall usage changes over time.

At 818, the monitoring platform causes the account services page, or a different account services page, such as the account services page 400 in FIG. 4 or the account services page 506 in FIG. 5B, to include a graph of the subscriber's usage over the period of time (e.g., the subscriber's average daily usage over a 30-day rolling period). The graph may include either or both of the subscriber's trendline and the overall plurality of subscribers' trendline, so that the subscriber can see how their usage compares relative to the average.

### Example Computing System

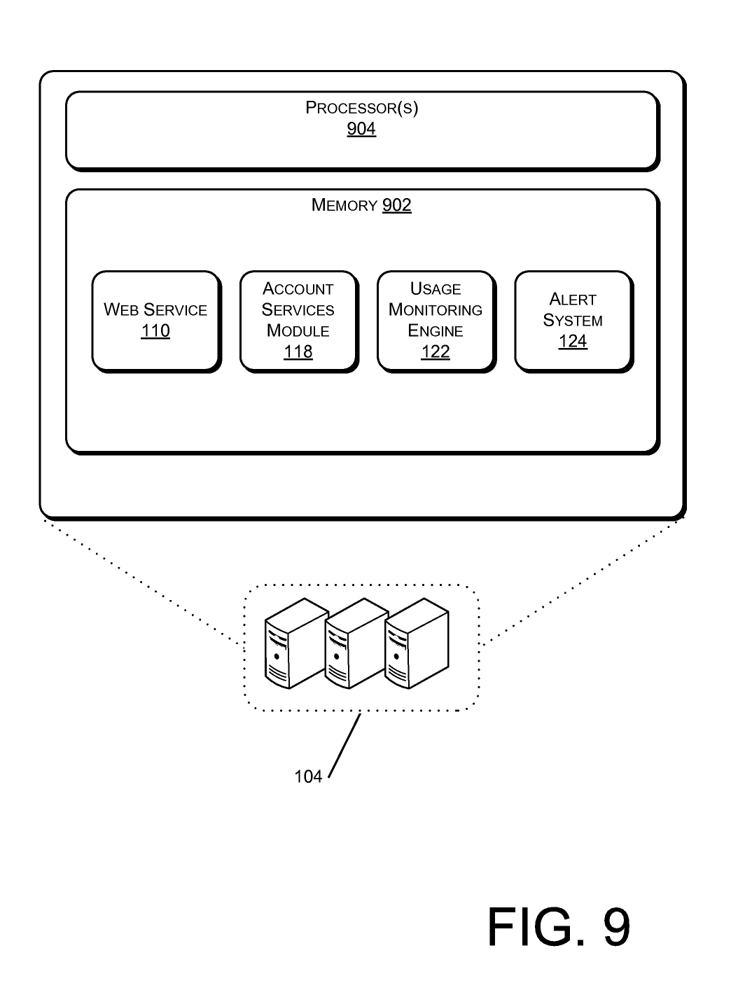

FIG. 9 is a block diagram of an example computing system usable to provide the monitoring platform. The monitoring platform 104 may be configured as any suitable computing device or computing devices capable of community-based monitoring. According to various non-limiting examples, suitable computing devices may include or be part of personal computers (PCs), servers, server farms, datacenters, special purpose computers, combinations of these, or any other computing device(s).

Memory 902 may store program instructions that are loadable and executable on the processor(s) 904, as well as data generated during execution of, and/or usable in conjunction with, these programs. For example, the memory 902 includes the web service 110, the account services module 118, the usage monitoring engine 122, and the alert system 124. Individual ones of the processor(s) 904 may include a circuit device having transistor circuits arranged in semiconductor substrate to perform arithmetic, logical, and/or input/output (I/O) operations, and configured to execute these operations according to an instruction set, such that the instruction set defines machine codes (e.g., operational codes or “opcodes”) that cause the transistor circuits to perform various ones of the operations responsive to the associated machine codes being copied to an instruction register(s) of the processor(s) 904.

### Computer-Readable Media

Depending on the configuration and type of computing device used, memory 902 may include volatile memory (such as random access memory (RAM)) and/or non-volatile memory (such as read-only memory (ROM), flash memory, etc.). Memory 902 may also include additional removable storage and/or non-removable storage including, but not limited to, flash memory, magnetic storage, optical storage, and/or tape storage that may provide non-volatile storage of computer-readable instructions, data structures, program modules, and other data.

Memory 902 is an example of computer-readable media. Computer-readable media includes at least two types of computer-readable media, namely computer storage media and communications media.

Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer-readable instructions, data structures, program modules, or other data in a modulated data signal, such as a carrier wave, or other transmission mechanism. As defined herein, computer storage media does not include communication media.

### CONCLUSION

Although the disclosure uses language that is specific to structural features and/or methodological acts, the invention is not limited to the specific features or acts described. Rather, the specific features and acts are disclosed as illustrative forms of implementing the invention.

We claim:

1. A method, comprising:
under the direction of one or more computing systems,
determining an overall service usage for a plurality of subscribers;
determining a service usage for a subscriber of the plurality of subscribers;
determining a metric that indicates a comparison of the service usage to the overall service usage; and
causing an indication of the metric to be transmitted to a device associated with the first subscriber.

2. The method of claim 1, wherein the metric is a percentile, and the indication of the metric indicates one of a plurality of ranges of percentiles that the service usage of the first subscriber falls into relative to the overall service usage for the plurality of subscribers.

3. The method of claim 1, wherein the metric is a number of standard deviations that the service usage of the first subscriber falls into relative to an service usage for the plurality of subscribers.

4. The method of claim 1, wherein the metric is a percentile, and wherein the indication of the metric indicates that the service usage for the first subscriber is:
within a first range of percentiles for which no action to reduce usage is designated, or
within a second range of percentiles for which action to reduce usage is designated.

5. The method of claim 4, wherein the indication of the metric indicates that the service usage for the first subscriber is within the first range, the second range, or a third range of percentiles for which the subscriber's usage indicates that they are nearing a usage level from which action to reduce usage is designated.

6. The method of claim 1, wherein the overall service usage and the service usage for the first subscriber are based on a rolling time period.

7. The method of claim 1, further comprising causing display, on the device associated with the first subscriber, a chart showing a first trend line of the first subscriber's usage over a period of time and a second trend line of the overall service usage over the period of time.

8. The method of claim 1, further comprising causing display, on the device associated with the first subscriber, a chart showing daily usage of the first subscriber over a period of time and at least one of a first trend line of the first subscriber's usage over the period of time or a second trend line of the overall service usage over the period of time.

9. The method of claim 1, wherein the overall service usage and the service usage for the first subscriber are associated with usage of at least one of a mobile phone service, an electricity service, or a water usage service.

10. The method of claim 1, wherein the metric further indicates a comparison of a first pollution level associated with the service usage of the first subscriber and a second pollution level associated with the overall service usage.

11. The method of claim 1, wherein the indication includes a bar, wherein the bar includes a first portion associated with a first range of usages and a second portion associated with a second range of usages, and a visual indication showing that the first subscriber's service usage falls into one of the first portion of the bar or the second portion of the bar.

12. The method of claim 1, wherein at least a second subscriber of the plurality of subscribers is within a social commerce network of the first subscriber, and wherein the method further comprises causing an indication of the first subscriber's metric to be displayed on a device associated with the second subscriber.

13. A computing system, comprising:
one or more processors; and
a memory, the memory comprising one or more software modules executable on the one or more processors to:
determine an overall rolling service usage by a plurality of service subscribers over a time period;
determine a rolling service usage by a first subscriber of the plurality of service subscribers over the time period;
determine a metric that indicates a comparison of the overall rolling service usage and the rolling service usage by the first subscriber; and
responsive to receipt of a request for an account page from a device associated with a first subscriber of the plurality of service subscribers, provide the account page to the device with an indication of the metric.

14. The computing system of claim 13, wherein the metric includes a percentile that the first subscriber's rolling service usage falls into relative to the overall rolling service usage.

15. The computing system of claim 13, wherein the indication includes an indication of a range within which the rolling service usage of the first subscriber's rolling service usage falls into relative to the overall rolling service usage.

16. The computing system of claim 13, wherein the one or more software modules are further executable by the one or more processors to:
calculate a first trend line showing a change in the first subscriber's rolling service usage over the time period; and
provide the account page, or another account page, showing the trend line relative to the first subscriber's rolling service usage over a plurality of time intervals of the rolling time period.

17. The computing system of claim 16, wherein the one or more software modules are further executable by the one or more processors to:
calculate a second trend line showing a change in the overall rolling service usage over the rolling time period; and
provide the account page, or the other account page, showing the second trend line relative to the first subscriber's rolling service usage over the plurality of time intervals of the rolling time period.

18. One or more computer-readable storage media comprising instructions executable by one or more processors of a computing system to cause the computing system to:
determine an overall service usage amount of a plurality of subscribers to a service;
determine a service usage amount of a particular subscriber of the plurality of subscribers;
categorize the service usage amount of the particular subscriber based on a comparison of the service usage amount to the overall service usage amount; and
flag the particular subscriber for service usage reduction based on the categorization.

19. The one or more computer-readable storage media of claim 18, wherein the instructions are further executable by one or more processors of the computing system to cause the computing system to categorize the service usage amount by a determination of a percentile of the overall usage amount that the service usage amount falls into.

20. The one or more computer-readable storage media of claim 18, wherein the instructions are further executable by one or more processors of the computing system to cause the computing system to provide an account services web page to a device associated with the particular subscriber, the account services web page including an indication of a category of the service usage amount.

21. The one or more computer-readable storage media of claim 20, wherein the account services web page further indicates that the particular subscriber has been flagged based on the categorization.

22. The one or more computer-readable storage media of claim 18 wherein the instructions are further executable by one or more processors of the computing system to cause the computing system to provide an account services web page to a device associated with the particular subscriber, the account services web page including a graph showing a trendline of the particular subscriber's average usage over a period of time and trendline of an overall average usage of the plurality of subscribers over the period of time.
